(19) United States
(12) Patent Application Publication
(10) Pub. No.: US 2008/0092345 A1
(43) Pub. Date: Apr. 24, 2008

(54) Security Hook with Blocking Member

(76) Inventors: Robert A. Dolan, Gilbert, AZ (US); David L. Simpson, Higley, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(21) Appl. No.: 11/960,613

(22) Filed: Dec. 19, 2007

Related U.S. Application Data
(62) Division of application No. 10/757,927, filed on Jan. 14, 2004, now abandoned.

(51) Int. Cl. F16G 17/00

(52) U.S. Cl. 24/370; 24/369

(57) ABSTRACT

A security hook includes a shaft with a chain receiving portion disposed at an end. The chain receiving portion has an arm and is configured to receive a chain. A blocking member protrudes from the shaft toward the arm of the chain receiving portion. The blocking member is configured to restrict disengagement of the chain from the chain receiving portion. The blocking member can be tapered to facilitate receiving the chain into engagement with the chain receiving portion. The arm of the chain receiving portion also can be tapered. A second blocking member can extend from the arm.

### RELATED APPLICATION DATA

This application is a divisional of and claims the priority of U.S. patent application Ser. No. 10/757,927 filed on Jan. 14, 2004, entitled “In-Line Security Hook,” which is hereby incorporated by reference.

### FIELD OF THE INVENTION

The present invention relates to security hooks, and more particularly to a security hook having a shaft with a blocking member formed to resist unplanned disengagement from a chain or the like.

### BACKGROUND

“S” hooks have been widely used as security chain end hooks, particularly in the trailer industry. In the trailer industry, chains with S-hooks are used as added security between the trailer and a towing vehicle. In use, these hooks may be engaged in a hole or slot in a vehicle frame, over the flanged edge of a channel-type frame, or with another chain. Oftentimes, the security chain hook is routed through a vehicle tie-down loop or around a frame member with the end hook then engaged over or through a link of the security chain. However, during vehicle operation, vibrations from road conditions or engine operation can cause the S-hook to disengage.

Different designs have been proposed to prevent disengagement of the S-hook during vehicle operation. For example, an S-hook having a protruding end that extends perpendicularly therefrom is known. The protruding end helps prevent the S-hook from coming disengaged. However, such a design is not always effective.

A long felt need exists for a security hook that resists unintentional disengagement and overcomes the other disadvantages of the prior art.

### SUMMARY OF THE INVENTION

A security hook is disclosed having a shaft including a first and a second opposing ends. A chain receiving portion is disposed on the first end of the shaft. The chain receiving portion has an arm and is configured to receive a chain. A blocking member protrudes from the shaft toward the arm and is in fixed relationship with the shaft. The blocking member is configured to restrict disengagement of the chain from the chain receiving portion. The blocking member also can be configured to facilitate receiving the chain into engagement with the chain receiving portion.

According to one embodiment of the invention, the blocking member is tapered to facilitate the installation of a chain in the chain receiving portion and to restrict the disengagement of the chain from the chain receiving portion. In one advantageous embodiment, the blocking member has a portion that is wider than the shaft and an inclined surface facing the arm. The arm of the chain receiving portion also can be tapered. A second blocking member can extend from the chain receiving portion, such as in a facing relationship with the shaft blocking member.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The accompanying drawings, which are incorporated in and constitute a part of the specification, illustrate the presently preferred embodiments of the invention and, together with the general description given above and the detailed description of the preferred methods and embodiments given below, serve to explain the principles of the invention.

The invention may be more readily understood by referring to the accompanying drawings in which

FIG. 1 is a side elevational view of a security hook in accordance with a preferred embodiment of the invention claimed in U.S. patent application Ser. No. 10/757,927.

FIG. 2 is a cross-sectional view taken along line 2-2 of the security hook shown in FIG. 1.

FIG. 3 is a front elevational view of the security hook of FIG. 1.

FIG. 4 is a side elevational view of a preferred embodiment of the security hook of U.S. patent application Ser. No. 10/757,927 engaged with a hole in a platform, showing the end portion not extending beyond the first bend.

FIG. 5 is a perspective view of a security hook engaged with a chain in accordance with another preferred embodiment of the invention of U.S. patent application Ser. No. 10/757,927.

FIG. 6 is a side elevational view of the security hook of FIG. 5.

FIG. 7 is a perspective view of a towing vehicle coupled to a trailer and having the security hook of FIG. 1 in combination with a chain as added security therebetween.

FIG. 8 is a right side elevational view of a security hook in accordance with one embodiment of the present invention.

FIG. 9 is a rear elevational view of the security hook of FIG. 8.

FIG. 10 is a left side elevational view of the security hook of FIG. 8 showing the arm in a closed position.

FIG. 11 is a cross-sectional view taken along line 11-11 of the security hook shown in FIG. 8.

FIG. 12 is a cross-sectional view taken along line 12-12 of the security hook shown in FIG. 8.

FIG. 13 is a cross-sectional view taken along line 13-13 of the security hook shown in FIG. 8.

FIG. 14 is a left side elevational view of a security hook in accordance with another embodiment of the present invention.

FIG. 15 is a front elevational view of the security hook of FIG. 14.

FIG. 16 is a right side elevational view of the security hook of FIG. 14 showing the arm in an open position.

FIG. 17 is a detailed cross-sectional view of detail 17 of the security hook shown in FIG. 16.

FIG. 18 is a cross-sectional view taken along line 18-18 of the security hook shown in FIG. 16.

FIG. 19 is a cross-sectional view taken along line 19-19 of the security hook shown in FIG. 16.

FIG. 20 is a cross-sectional view taken along line 20-20 of the security hook shown in FIG. 16.

FIG. 21 is a side elevational view of a preferred embodiment of the security hook of the present invention.

FIG. 22 is a front elevational view of the security hook of FIG. 21.

FIG. 23 is a partial cross-sectional view taken along line 23-23 of the security hook shown in FIG. 21.

FIG. 24 is a perspective view of the security hook of FIG. 21 engaged with a chain, wherein the arm of the chain receiving portion is inserted through a chain link.

FIG. 25 is a perspective view of the security hook of FIG. 21 engaged with a chain, wherein the arm of the chain receiving portion is positioned over a chain link.

FIG. 26 is an elevational view of another embodiment of the security hook of the present invention having first and second blocking members.

Like numerals refer to like parts throughout the several views of the drawings.

### DETAILED DESCRIPTION

An embodiment of a security hook 10, as shown in FIGS. 1 through 3, includes a chain receiving portion 12, a main shaft 14, a first bend 16 and a second bend 18. The main shaft 14 has first and second opposite ends 14a, 14b. The chain receiving portion 12 is disposed at the first end 14a of the main shaft 14 and is preferably integrally attached to the main shaft 14. In one embodiment, the chain receiving portion 12 and main shaft 14 are made of an integral piece of metal bar stock and the chain receiving portion 12 is formed by bending the end of the metal bar stock toward the main shaft 14.

Initially, arm 12a of the chain receiving portion 12 extends substantially parallel to the main shaft 14 toward the second bend 18. The term “substantially” is defined as “being largely but not wholly that which is specified.” “Substantially parallel” is used herein to indicate components that extend in the same direction in a largely equidistant relationship. However, “substantially parallel” does not require the components to be exactly parallel. Following attachment of security hook 10 to a chain, arm 12a is formed further toward main shaft 14 (shown in phantom in FIG. 1) to prevent unintended separation of hook 10 from the chain. In an alternative embodiment, the chain receiving portion 12 is an eye (not shown) welded to the main shaft 14.

As best shown in FIG. 1, the first bend 16 extends from the second end 14b of the main shaft 14 and includes a first straight portion 16a. Preferably, the first bend 16 extends upwardly toward the same side of the main shaft 14 as the chain receiving portion 12 such that the first bend 16 is arranged vertically in-line with the chain receiving portion 12. “In-line” is used herein to indicate that the chain receiving portion 12 and the first bend 16 are positioned on the same side as the main shaft 14, and the first bend 16 is positioned generally in a straight vertical line with respect to the chain receiving portion 12. It is to be understood that the term “vertical” is used herein to refer to the orientation of the components as shown in FIG. 3. It will be further understood that the chain receiving member also may reside on the opposite side of the main shaft 14.

As shown in FIG. 1, the second bend 18 bends in the opposite direction as the first bend 16. The first bend 16 bends upwardly from the main shaft 14 and the second bend 18 bends downwardly from the first straight portion 16a. The second bend 18 extends from the first straight portion 16a and includes second straight portion 18a that terminates in a hook end 22. In one embodiment, the second bend 18 extends directly from the first bend 16, eliminating the first straight portion 16a. Similarly, the second straight portion 18a can be eliminated causing the second bend to terminate in a hook end 22.

Also as shown in FIG. 1, the first straight portion 16a is substantially parallel with the main shaft 14, and the second straight portion 18a is substantially parallel with the first straight portion 16a and the main shaft 14. As best shown in FIGS. 4 and 6, arm 12a is not parallel to the main shaft 14, but is inclined such that the end 26 of arm 12a is approaching the main shaft 14. A gap 24 is defined between the arm 12a and the main shaft 14. Gap 24 is preferably dimensioned to prevent separation of receiving portion 12 from a chain and to restrict the inadvertent disengagement of a chain from first bend 16 of security hook 10.

The security hook 10 can be made of any rigid material, such as metal, plastic, composite, etc. The material used to form the security hook 10 preferably has a yield strength sufficient to withstand loads required of a trailer security chain hook. In a preferred embodiment of the invention, the security hook 10, including the chain receiving portion 12, the main shaft 14, the first bend 16, and the second bend 18, is preferably formed from a single integral metal bar. Alternatively, the elements of the security hook 10 can be separately made and thereafter welded together.

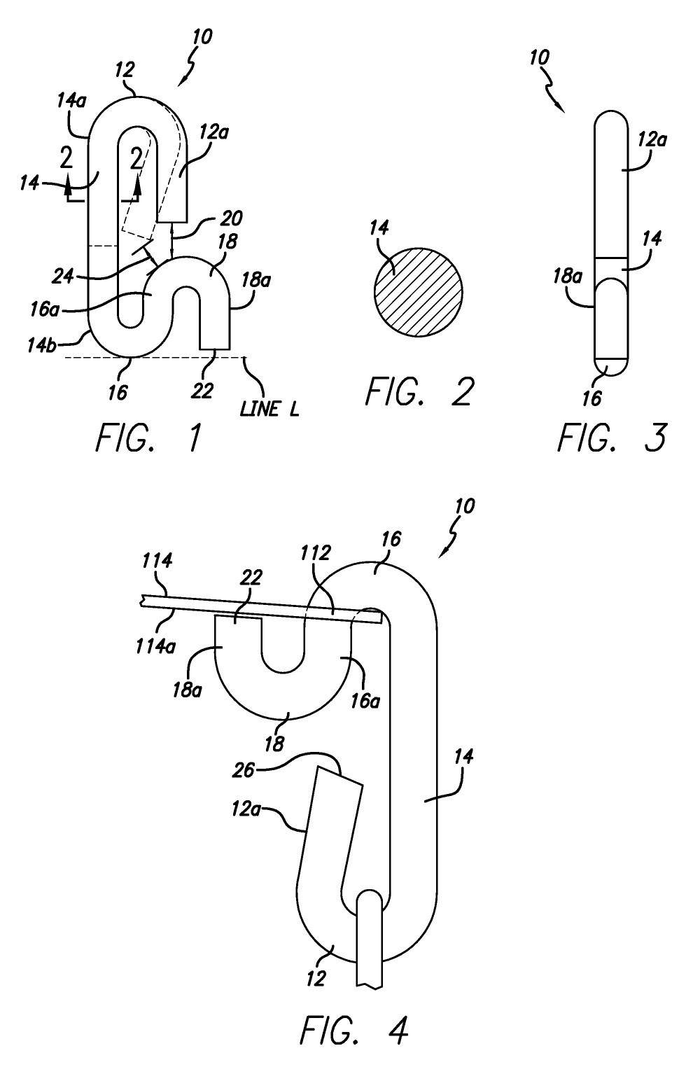

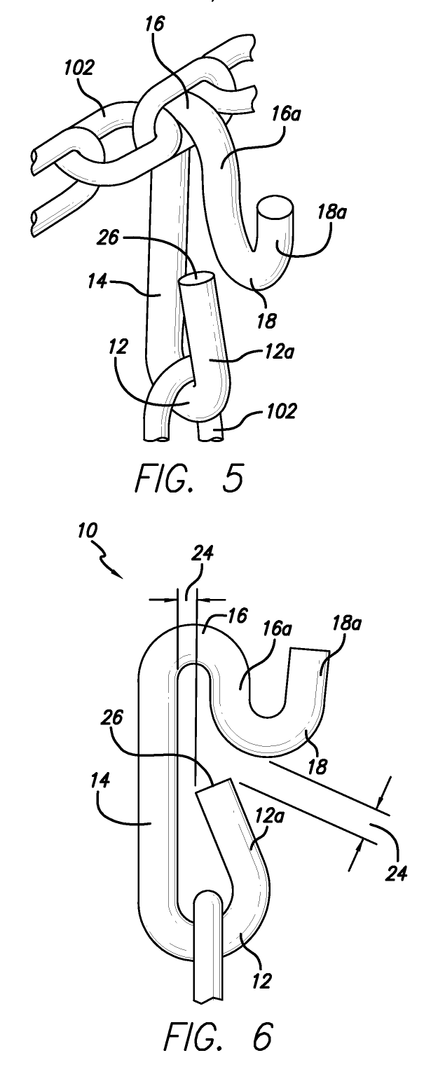

The security hook preferably has a circular cross-section, as best shown in FIG. 2. The cross-section, however, is not limited to the embodiment shown but can be of any shape, including, oval, rectangular or any other shape. As best shown in FIG. 3, the main shaft 14, first bend 16 (including the first straight portion 16a), and the second bend 18 (including the second straight portion 18a) are co-planar and define a plane P.

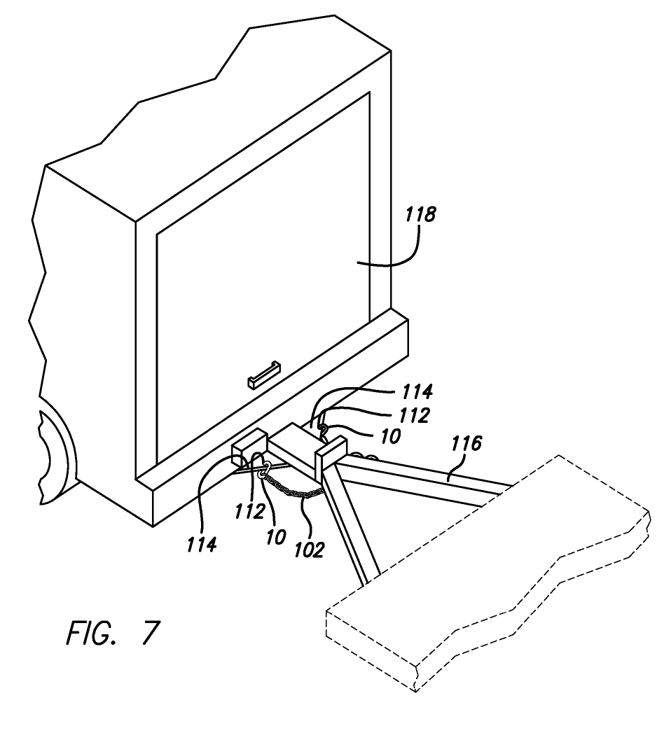

In one embodiment, as best shown in FIG. 1, hook end 22 does not extend beyond (or below) the first bend 16. The lower limit of the first bend 16 is illustrated in FIG. 1 by line L which extends along the bottom edge of the first bend 16. If hook end 22 extended beyond line L, the use of the security hook 10 in certain applications would be limited. For example, as shown in FIG. 7, security hook 10 is used to connect a chain 102 extending from a trailer 116 to a platform 114 of a towing vehicle 118. A preferred method of connecting the chain 102 to the towing vehicle 118 using the security hook 10 is now described in reference to FIGS. 4 and 7. To engage the security hook 10 with the platform 114, the hook end 22 of the security hook 10 is inserted into the hole 112. The security hook is pivoted downwardly to allow the second straight portion 18a to enter the hole 112 until the second bend 18 is received in the hole 112. At such point as the first and second straight portions 16a, 18a are substantially parallel with the platform 114, the security hook 10 is pivoted further downwardly such that the first straight portion 16a is received in the hole 112. Once the first bend 16 rests atop the plate 114, the process is completed and the security hook 10 is at rest in the position shown in FIG. 4. A person skilled in the art can modify the steps of installing the security hook on the platform without departing from the scope of this method.

When the security hook 10 is properly installed, hook end 22 rests on the underside 114a of the platform 114 and the main shaft 14 extends in a substantially perpendicular relationship to the platform 114. If the hook end 22 extended beyond line L (shown in FIG. 1), the security hook 10 could not be positioned on the platform 114 as depicted in FIG. 4. Rather, the security hook would rest in an awkward and inefficient position.

The use of the security hook 10 to connect a chain 102 from a trailer 116 to the platform 114 of a towing vehicle 118 is described for exemplary purposes only. It will be understood by those skilled in the art that there are numerous other uses of the security hook 10.

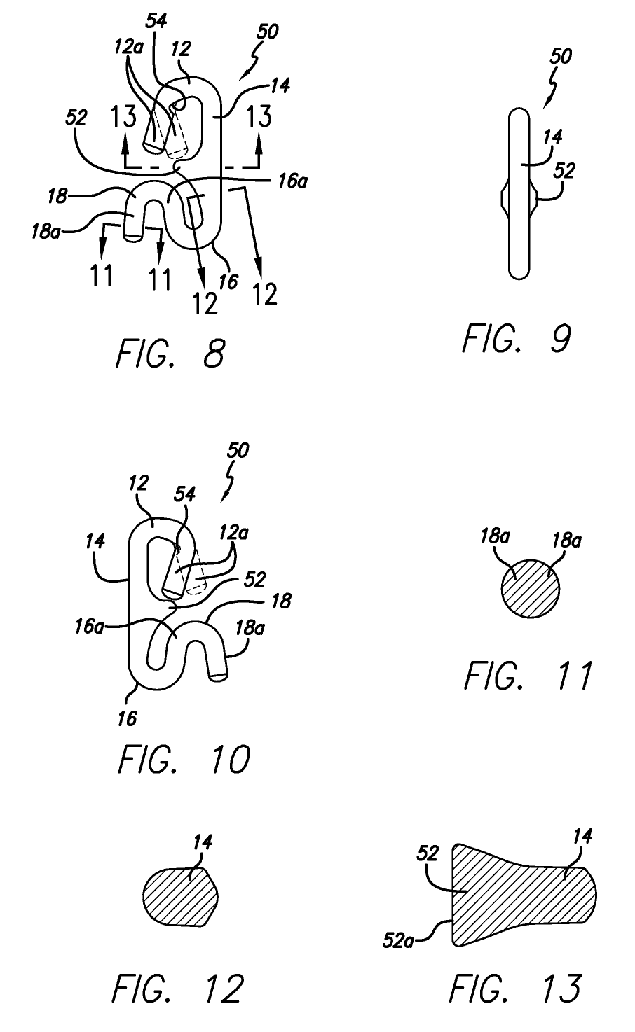

Referring now to FIGS. 8-13, one embodiment of a security hook 50 in accordance with the present invention is shown. In this embodiment, the main shaft 14 of the security hook 50 includes a protrusion 52 thereon. The chain receiving portion 12 has a notch 54 defined on an inside surface thereof. The notch 54 is preferably defined where the arm 12a meets the remainder of the chain receiving portion 12, as is shown in FIG. 8.

In one embodiment, the arm 12a defines an open position (as shown in FIG. 8) and a closed position (as shown in FIG. 10). Prior to use, the arm 12a is in the open position. A chain is placed on the chain receiving portion 12 and then the arm 12a is further formed to the closed position. It will be appreciated that the arm 12a will form predictably to the closed position due to the reduced cross-sectional area at the notch 54.

It will also be appreciated that the protrusion 52 is positioned such that when the arm 12a is formed to the closed position that the arm 12a (chain receiving portion 12) and protrusion 52 cooperate to ensure that the chain cannot come out or off of the chain receiving portion 12, i.e., the space between the end of the arm 12a and the protrusion 52 is of a smaller dimension than the cross-sectional width of the chain. Preferably, the end 52a of the protrusion is also wider than the main shaft 14. This can be best seen in FIGS. 9 and 13.

In one embodiment, the protrusion 52 has the cross-sectional shape shown in FIG. 13. However, it will be understood that the protrusion 52 can have any cross-sectional shape that cooperates with the arm to prevent the chain from coming off of the chain receiving member 12.

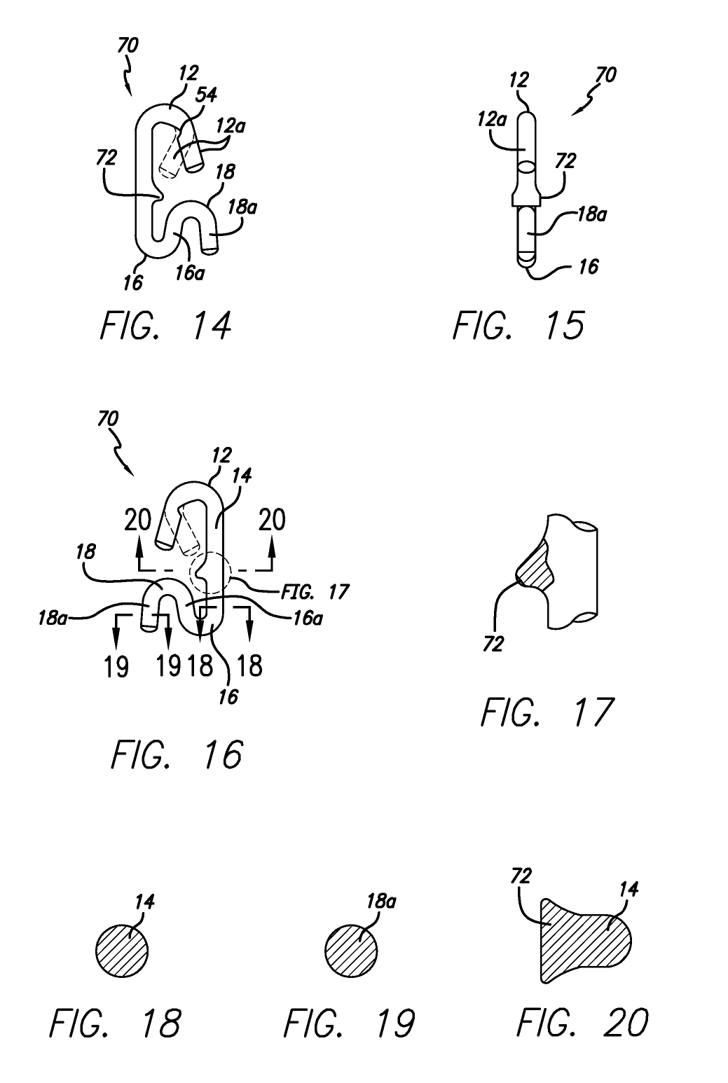

Referring now to FIGS. 14-20, another embodiment of a security hook 70 in accordance with the present invention is shown. In this embodiment, the main shaft 14 of the security hook 70 includes a protrusion 72 with the cross-sectional shape shown in FIG. 20.

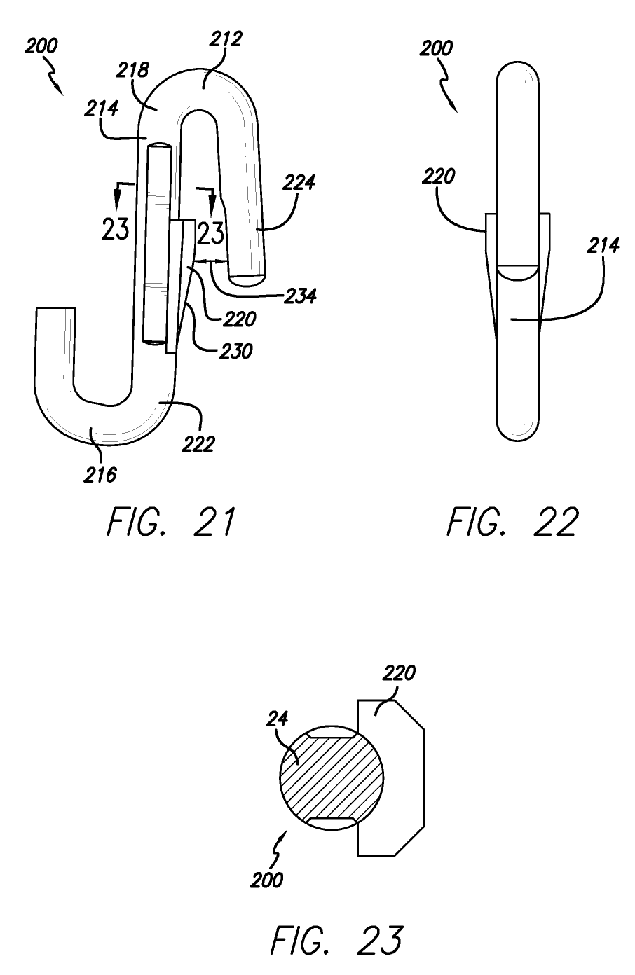

As shown in FIGS. 21-24, a preferred embodiment of the security hook 200 of the present invention includes a chain receiving portion 212, a main shaft 214 and a first bend 216. The main shaft 214 has a first end 218 and a second opposing end 222. The chain receiving portion 212 is preferably integrally attached to the main shaft 214 at the first end 218 and the first bend 216 is preferably integrally attached to the main shaft 214 at the second end 222. In a preferred embodiment of the invention, as shown in FIGS. 21-23, the security hook 200 includes a blocking member 220 that also is integrally attached to the main shaft 214. Blocking member 220 preferably protrudes from the main shaft 214 toward an arm 224 of the chain receiving portion 212 and is configured to prevent a chain from exiting the chain receiving portion 212 of the security hook 200.

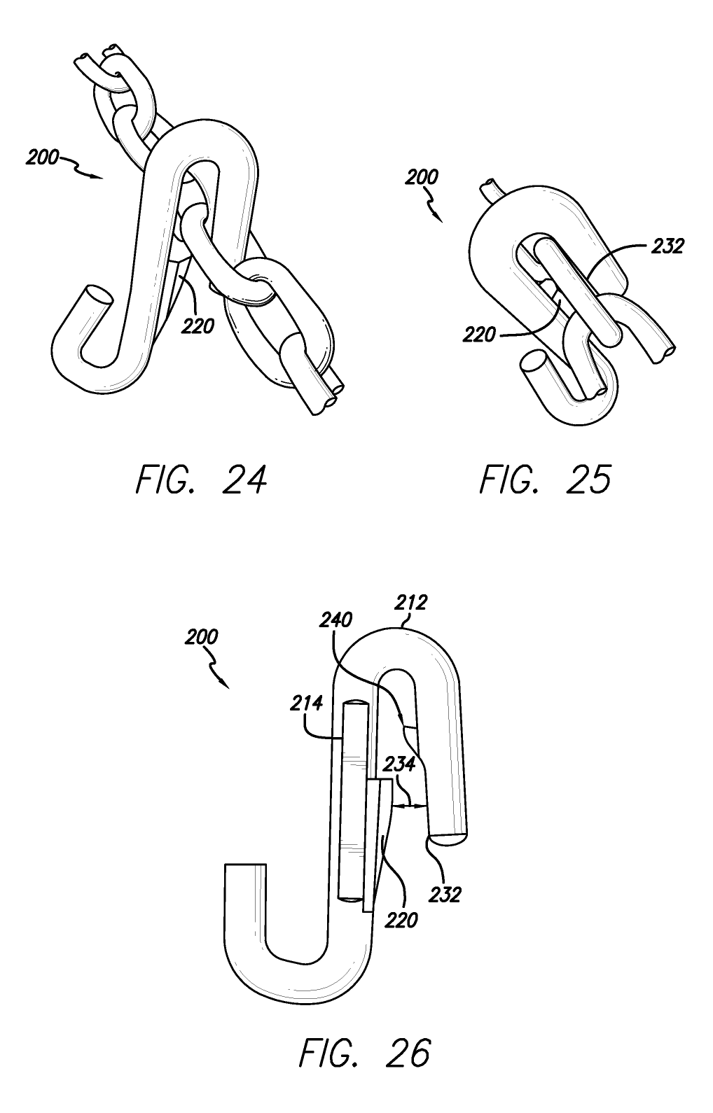

As shown in FIG. 21, the blocking member 220 preferably has an inclined surface 230, and has a tapered shape. As can best be seen in FIGS. 22 and 23, the larger end of the tapered blocking member 220 is wider than the diameter of the main shaft 214. The closest distance between the larger end of the blocking member 220 and the arm 224 is slightly larger than the diameter of a chain link. When the chain is being installed on the security hook 200, the inclined surface 230 aids in the alignment of the chain with the chain receiving portion 212, thereby facilitating the installation of the chain in the chain receiving portion 212. Once the chain is installed, as shown in FIG. 24, upon angular movement of the chain with respect to the security hook 200, the blocking member 220 restricts the movement of the chain making it impossible for the chain to become inadvertently disengaged from the security hook 200.

FIG. 24 shows the security hook 200 holding the chain with the arm 224 of the chain receiving portion 212 inserted through a link of the chain. FIG. 25, on the other hand, shows the security hook 200 holding the chain with the arm 224 of the chain receiving portion 212 positioned over the chain link but not inserted through the link. Advantageously, in either arrangement (i.e. that of FIG. 24 or that of FIG. 25), the blocking member 220 restricts the movement of the chain link and prevents the chain from becoming disengaged from the security hook 200. Thus, as shown in FIGS. 24 and 25, the blocking member 220 can prevent disengagement of the chain from the security hook even if the security hook is installed over a chain link rather than through a chain link. In the preferred embodiment of FIGS. 21-24, the arm 224 of the security hook 200 has a tapered inner surface 232. The tapered surface 232 gives the security hook 200 a slightly larger opening 234 at the entry end, but pushes the chain link closer to the blocking member 220 once the chain is inserted through the opening 234.

As shown in FIG. 26, in another preferred embodiment of the present invention, security hook 200 includes a second blocking member 240. The second blocking member 240 is preferably positioned in an opposite facing relationship with the first blocking member 220. The first and second blocking member 220, 240 cooperate to further restrict the movement of a chain within the chain receiving portion 212, thus ensuring that the chain remains engaged with the chain receiving portion 212.

The embodiments of the present invention recited herein are intended to be merely exemplary and those skilled in the art will be able to make numerous modifications to them without departing from the spirit of the present invention. All such modifications are intended to be within the scope of the present invention as defined by the claims appended hereto.

What is claimed is:

1. A security hook comprising:
a shaft having a first and a second opposing ends;
a chain receiving portion disposed on the first end of the shaft, wherein the chain receiving portion includes an arm and is configured to engage a chain; and
a blocking member protruding from the shaft toward the arm and in fixed relationship with the shaft, wherein the blocking member is configured to restrict disengagement of the chain from the chain receiving portion.

2. The security hook of claim 1 wherein the blocking member is also configured to facilitate receiving the chain into engagement with the chain receiving portion.

3. The security hook of claim 1 wherein the blocking member includes a taper.

4. The security hook of claim 1 wherein the arm of the chain receiving portion includes a taper.

5. The security hook of claim 1 wherein the blocking member includes an inclined surface facing the arm.

6. The security hook of claim 1 wherein the blocking member includes a portion that is wider than the shaft.

7. The security hook of claim 1 further comprising a second blocking member protruding from the arm of the chain receiving portion.

8. The security hook of claim 1 further comprising a bend disposed on the second end of the shaft.

9. A security hook comprising:
a shaft having a first and a second opposing ends;
a chain receiving portion disposed on the first end of the shaft, wherein the chain receiving portion includes an arm and is configured to receive a chain therein;
a blocking member protruding from the shaft toward the arm, wherein the blocking member and the arm define an opening for receiving a chain into the chain receiving portion; and
wherein the blocking member is substantially immovable with respect to the shaft and is configured to restrict the chain from exiting the chain receiving portion through the opening.

10. The security hook of claim 9 wherein the blocking member includes a taper.

11. The security hook of claim 9 wherein the arm of the chain receiving portion includes a taper.

12. The security hook of claim 9 wherein the blocking member includes an inclined surface facing the arm.

13. The security hook of claim 9 wherein the blocking member includes a portion that is wider than the shaft.

14. The security hook of claim 9 further comprising a second blocking member protruding from the chain receiving portion.

15. The security hook of claim 9 further comprising a bend disposed on the second end of the shaft.

16. A security hook, comprising:
a shaft having a first and a second opposing ends;
a chain receiving portion disposed on the first end of the shaft, the chain receiving portion having an arm and configured for receiving a chain therein; and
a blocking means for restricting the chain from exiting the chain receiving portion, wherein the blocking means includes a protrusion that extends from the shaft toward the arm in fixed relationship with the shaft.

17. The security hook of claim 16 wherein the protrusion facilitates receiving the chain into engagement with the chain receiving portion.

18. The security hook of claim 16 wherein the protrusion and the arm define an opening for receiving the chain into the chain receiving portion and wherein the chain can be inserted through the opening when the chain is in a first angular orientation and is restricted from exiting the opening when the chain is in another angular orientation.

19. The security hook of claim 16 wherein the protrusion has a portion that is wider than the shaft.

20. The security hook of claim 16 wherein the protrusion has a taper.
